(19) United States
(12) Patent Application Publication
(10) Pub. No.: US 2007/0216131 A1
(43) Pub. Date: Sep. 20, 2007

(54) Office chair

(75) Inventor: Willem Hendrik Potappel, Da Epe (NL)

Correspondence Address: BERESKIN AND PARR, 40 KING STREET WEST, BOX 401, TORONTO, ON, M5H 3Y2, CA

(73) Assignee: REVAB B.V., Silvolde (NL)

(21) Appl. No.: 11/374,047

(22) Filed: Mar. 14, 2006

(51) Int. Cl. B62M 1/14

(52) U.S. Cl. 280/250.1

(57) ABSTRACT

An office chair includes a base and a height adjustable seat mounted to the base and having a front end. The base includes a pair of centrally positioned, laterally spaced apart drive wheels that are manually operated by a user or which are motorized.

### FIELD OF THE INVENTION

This invention relates to office chairs. In particular, this invention relates to chairs that can be used in work place environments, such as offices, by people with physical impairments wherein mobility is required to access material or equipment at various locations and various heights.

### BACKGROUND

Office chairs are known in the art. Typically, an office chair has a wheeled base or a slide base. The seat of the chair is mounted on a telescopic gas cylinder to permit the height of the seat to be adjusted. Such chairs are not adapted for use by people with physical impairment to their legs since such a person may not be able to easily stand up and walk across an office to work at a different location or to obtain material required for their work.

Wheel chairs are also known in the art. A variety of designs are known. In order for a wheel chair to provide a stable platform for a person when sitting down in the wheel chair or standing up from a wheel chair, wheel chairs typically have a large foot print. This makes them undesirable in many work place environments.

U.S. Pat. No. 3,953,054 (Udden et al.) discloses a hand operated wheel-chair having a pair of main wheels rigidly connected to the frame-work of the chair, at least one of which is either motor or hand operated, two forwardly positioned castor wheels, and two rearwardly positioned support wheels. The castor wheels and the support wheels are mounted in different planes above the ground surface so that either the castor wheels or the support wheels are in contact with the ground surface at any one time. Therefore, the chair may rock forwards or rearwardly as the vertical through the center of gravity is moved from one side to the other side of the main wheels. The wheel chair also comprises a seat that is mounted on a central column. A jack is provided for adjusting the height of the seat.

One disadvantage of the wheel chair of Udden et al is that it does not provide a stable seat as it may rock forwards and rearwardly. This disadvantage is exacerbated when the seat is raised. In particular, when the seat is raised, the centre of gravity of the chair and the occupant is raised. As the chair can rock forwardly and rearwardly about the main wheels, the raised centre of gravity increases the likelihood the chair could tip over, thereby posing an increased safety risk. In addition, the wheel chair of Udden et al has a footrest that extends forwards of the forward caster wheels, thereby increasing the size of the footprint of the chair and limiting its mobility in an office environment.

### SUMMARY OF THE INVENTION

In accordance with the instant invention, an office chair is provided with position adjustability features typically associated with office chairs, and mobility features typically associated with wheel chairs, all in a single seating apparatus. The office chair provides increased mobility in an office environment and permits an employer to hire a disabled person without having to purchase a desk designed for use with a wheel chair, and other custom or disabled-specific office equipment, such as file cabinets wherein all the shelves are positioned such that a person can reach to pick up files while seated at the normal seat height of a wheelchair. Accordingly, the employer is more able to treat a disabled employee as a non-disabled employee and move the disabled employee to different positions in an office with fewer concerns. The disabled person can more easily be integrated in an office having disabled and non-disabled employees, reducing barriers to employment and improving morale and self-esteem of disabled persons.

An occupant may use this single seating apparatus to travel between one or more workstations in an office which may be on different levels requiring the occupant to travel up or down a ramp, or between home and office, for example, and use the same seating apparatus to comfortably position himself or herself when working at any particular workstation for an extended period of time. In particular, the chair preferably has a seat, backrest and, optionally arms, that may be any of those known in the office chair art so that an occupant may be seated comfortably for a normal work shift. This can avoid or reduce the need for providing multiple chairs at respective locations for a particular person, storing and/or transporting chairs, and making difficult (and often dangerous) transfers between chairs.

In accordance with one aspect of the instant invention, there is provided an office chair comprising:

(a) a base comprising:
(i) a pair of centrally positioned, laterally spaced apart drive wheels, the drive wheels having a radius and a top portion;
(ii) at least one forward support wheel mounted at a fixed height;
(iii) at least one rearward support wheel pivotally mounted to the office chair about a horizontal axis; and,

(b) a height adjustable seat mounted to the base and having a front end.

In order to render an office accessible to a disabled person, ramps are typically provided. One advantage of this embodiment of the invention is that the front and rear support wheels are in contact with the floor so as to enhance the stability of the chair. However, as the rearward support wheels are pivotally mounted, then these wheels may deflect upwardly or downwardly as the chair is moved up or down a ramp thus permitting the drive wheels of the chair to remain in contact with the floor (and function as drive wheels) even when the office chair is moved up a ramp.

In one embodiment, the office chair further comprises a seat height adjustment motor drivingly connected to the seat. Preferably, the office chair further comprises a battery connected to the motor. The motor may be controlled by a switch or button that may be provided on the arm of the chair, if the chair is provided with arms. Alternately, the switch or button is preferably positioned at a location that the occupant can reach while seated in the chair, such as underneath the seat.

In another embodiment, the height of the seat is adjustable from a position below the top portion of the drive wheels to a position above the top portion of the drive wheels. This enhances the ability of a disabled person to access material at different heights while seated in the chair. For example, by raising the seat, an occupant may be able to reach a shelf that is above shoulder height when seated in a standard wheelchair. Preferably, the drive wheels are provided with brakes. The brakes may be engaged prior to the seat being raised so as to reach an object of an upper shelf.

In another embodiment, the seat is non-rotatably mounted to the base.

In another embodiment, the forward support wheels and the rearward support wheels are rotatably mounted to the base. Preferably, the forward support wheels and the rearward support wheels comprise casters. An advantage of this embodiment is that the ability of the office chair to rotate about a central point is enhanced.

In another embodiment, the forward support wheels and the rearward support wheels are mounted on arms and the arms are non-rotatably mounted with respect to the drive wheels.

In another embodiment, the forward support wheels and the rearward support wheels are laterally positioned between the drive wheels.

In another embodiment, the forward support wheels and the rearward support wheels extend forwardly less than the radius of the drive wheels. An advantage of this embodiment is that the footprint of the office chair is further reduced.

In another embodiment, the drive wheels are sized to be manually operated by a person when seated in the office chair. For example, the diameter of the drive wheels may be the same as those used in wheelchairs and is preferably about two feet. An advantage of this embodiment is that the occupant may themselves propel the chair as if it were a wheel chair.

In another embodiment, the office chair has a pair of forward support wheels and rearward support wheels and the forward support wheels and the drive wheels are positioned to define an open area in front of the seat whereby a person's feet can touch the surface on which the office chair is situated while seated in the chair and move the office chair with their feet. An advantage of this embodiment is that the occupant may trippel the office chair, i.e. move the office chair with their feet. An occupant may become tired if they have to continually move the office chair by manually rotating the drive wheels. By configuring the chair to permit the occupant to also move the chair with their feet, the user may, from time to time, rest their arms. Further, the occupant may be able to move the chair while holding a file or other work material in their hands.

In another embodiment, the office chair further comprises a footrest that is mounted at a position rearward of the front end of the seat. An advantage of this embodiment is that the occupant may be able to rest their feet above the ground, in a more ergonomic position, without increasing the footprint of the chair and decreasing the mobility of the chair. Preferably, the footrest is pivotally mounted between a generally horizontal in use position and a generally vertical storage position.

In another embodiment, the office chair further comprises a seat back wherein the inclination of the seat back with respect to the vertical is adjustable. It will be appreciated that alternately, or in addition, the inclination of the seat may be adjustable and the chair may have arms which may be adjustable.

In another embodiment, the office chair further comprises a drive motor drivingly connected to the drive wheels. Thus, the occupant may be able to move the chair by using a joy stick or other control mechanism known in the art.

It will be appreciated that the various embodiments may be combined in various combinations and sub-combinations to provide different preferred embodiments of this invention. For example, in accordance with another embodiment of the instant invention, there is also provided an office chair comprising:

(a) a base comprising:
(i) a pair of centrally positioned, spaced apart drive wheels;
(ii) at least one forward support wheel;
(iii) at least one rearward support wheel;

(b) a height adjustable seat mounted to the base and having a front end; and,

(c) a seat height adjustment motor drivingly connected to the seat.

In accordance with another embodiment of the instant invention, there is also provided an office chair comprising:

(a) a base comprising:
(i) a pair of centrally positioned, spaced apart drive wheels;
(ii) forward support wheels;
(iii) rearward support wheels; and,

(b) a height adjustable seat mounted to the base and having a front end;

wherein the office chair is configured to define an open area in front of the seat whereby a person's feet can touch the surface on which the office chair is situated while seated in the chair and move the office chair with their feet.

Other aspects and features of the Applicant's teaching will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of an office chair embodying one or more aspects of the applicant's teaching;

FIG. 2 is a left side view of the chair of FIG. 1, with the seat portion in a lowered position;

FIG. 3 is a right side view of the chair of FIG. 1, with the seat portion in a raised position;

FIG. 4 is a left side view of the chair of FIG. 1, with the seat portion in a raised position and showing additional and/or optional features thereof in greater detail;

FIG. 5 is a perspective exploded view of the chair of FIG. 1;

FIG. 6 is a bottom plan view of part of the base portion of FIG. 5;

FIG. 7 is a cross sectional view of part of the structure of FIG. 5, taken along the line 7-7 of FIG. 6;

FIG. 8 is an enlarged view of a portion of the structure shown in FIG. 7;

FIG. 9A is an exploded perspective view of the structure of FIG. 8;

FIG. 9B is a non-exploded partial cut-away view of the structure of FIG. 9A; and

FIG. 10 is a front elevation view of the chair of FIG. 1.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

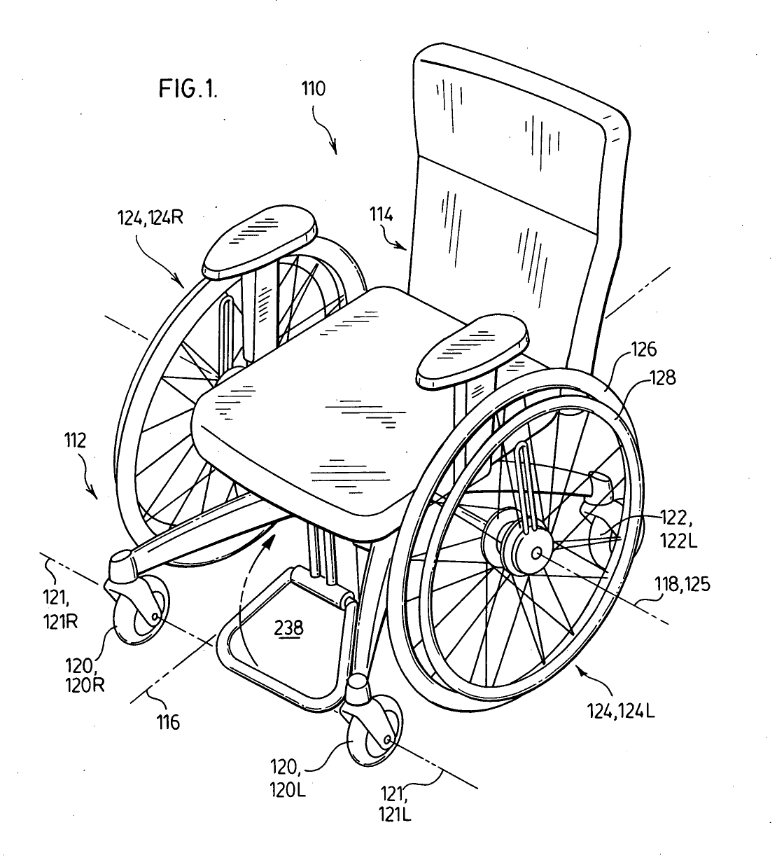

An office chair 110 in accordance with the applicant's teaching is shown in FIG. 1. The office chair 110 includes a base 112 and a seat assembly 114 supported by the base 112. The chair 110 generally defines a longitudinal axis 116 extending front to back of the chair 110, and a transverse (or lateral) axis 118 extending generally normal to the longitudinal axis 116, between left and right sides of the chair.

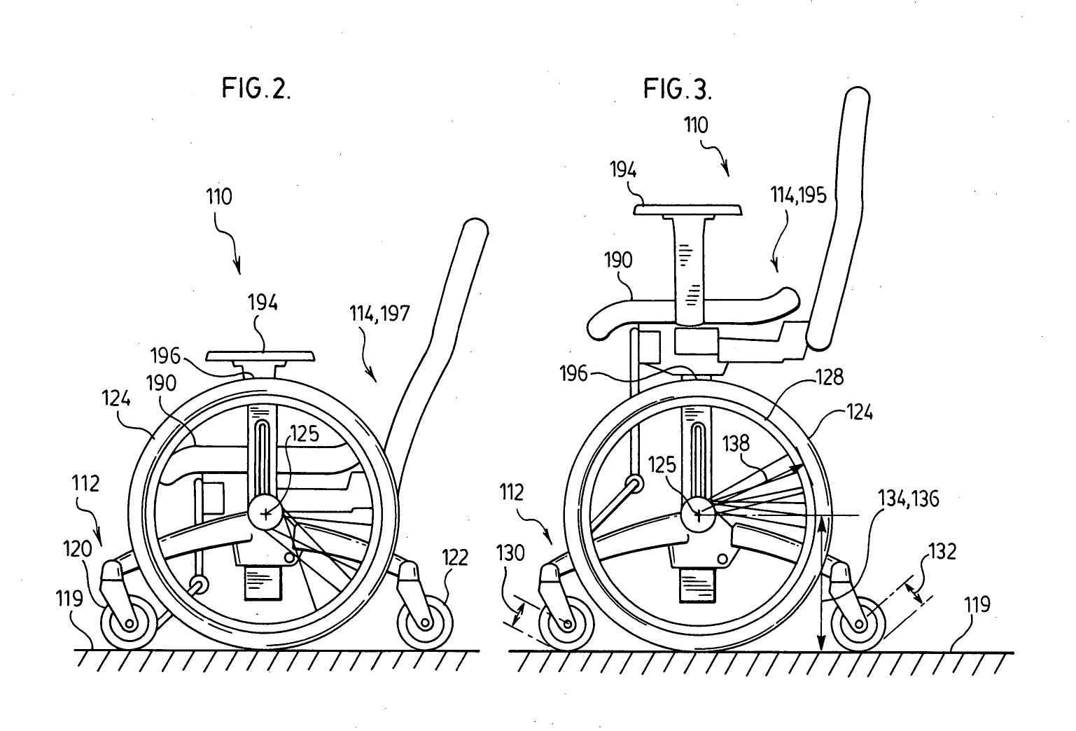

Referring also to FIGS. 2 and 3, the chair 110 has a plurality of support wheels secured thereto for supporting the chair 110 on a surface 119. The support wheels include at least one front support wheel 120 and at least one rear support wheel 122. Preferably, as shown, the support wheels include a pair of laterally spaced apart front support wheels 120, and a pair of laterally spaced apart rear support wheels 122. The front and rear support wheels 120, 122 rotate about respective front and rear wheel horizontal axes 121, 123 adjacent respective longitudinally spaced apart front and rear ends of the chair 110. Individual left and right elements of pairs of elements are denoted with “L” and “R” suffixes appended to the respective reference character.

The chair 110 preferably comprises a pair of laterally spaced apart drive wheels 124 rotatable about a horizontal drive wheel axis 125 and positioned longitudinally intermediate the front and rear support wheels 120, 122, and preferably with the axis 125 in line with the seat support column 202. The drive wheels 124 (including left and right drive wheels 124L, 124R) are adapted to facilitate movement of the chair 110 with an occupant therein across the surface 119, which can comprise, for example, a floor in an office. The drive wheels 124 can also facilitate moving the chair 110 over considerably longer distances, and can generally provide an occupant with a similar level of mobility to that afforded by a conventional wheelchair. The drive wheels 124 may be rotated manually by an occupant of the seat 110, or may be powered or power-assisted to effect rotation of the drive wheels 124, thereby moving the chair 110 over the surface 119. The base 112 is preferably designed to result in the drive wheels 124 contacting the surface 119, even when the chair 110 moves across or straddles a transition in elevation of the surface 119, as further discussed hereinafter.

The drive wheels 124 may be any drive wheels known in the wheel chair art. Preferably, drive wheels 124 are sized so as to be manually rotated by an occupant of the chair 110. Accordingly, drive wheels 124 may comprise a ground-contacting tire portion 126 and a hand rim portion 128 (FIG. 1) adjacent the tire portion 126 and adapted to be grasped by the hand of an occupant for moving the chair 110 with respect to the surface 119 on which the chair 110 is situated. The front support wheels, rear support wheels, and drive wheels 120, 122, 124 each have a corresponding front, rear, and drive wheel radius 130, 132, 134 (FIG. 3). The drive wheel radius 134 is, in the example illustrated, generally equal to the radius of the tire portion 126 (i.e. the tire portion radius 136). The hand rim 128 may have a hand rim radius 138 that is less than the tire portion 136 radius 136. In the embodiment illustrated, the front support wheel radius 130 is about 75 mm, the rear support wheel radius 132 is generally equal to the front support wheel radius 130, and the drive wheel radius 134 is about 300 mm.

When moving the chair 110 across an office or over longer distances, the surface 119 may be uneven over portions thereof, presenting height inconsistencies (or transitions in elevation) such as, for example, inclines or relatively small steps in height associated with a change in flooring elevation. In accordance with one preferred embodiment, front support wheels, rear support wheels, and drive wheels are configured such that drive wheels 124 remain in engagement with the surface 119 when traveling over such height inconsistencies so that control and propulsion of the chair 110 over the surface 119 is not impeded. Accordingly, preferably at least one of the front and rear pair of wheels 120, 122 are adjustably mounted to the base 112 so that the respective axis 121, 123 about which the at least one pair of wheels 120, 122 rotate can move between vertically raised and lowered positions, and/or between a vertically neutral, raised and lowered positions, relative to the drive wheel axis 125. More preferably, only one of the front and rear pair of wheels 120, 122 is adjustably mounted to the base 112 and, most preferably, the rear pair of wheels 122 are adjustably mounted to the base 112. The adjustable mounting is preferably a pivot mount.

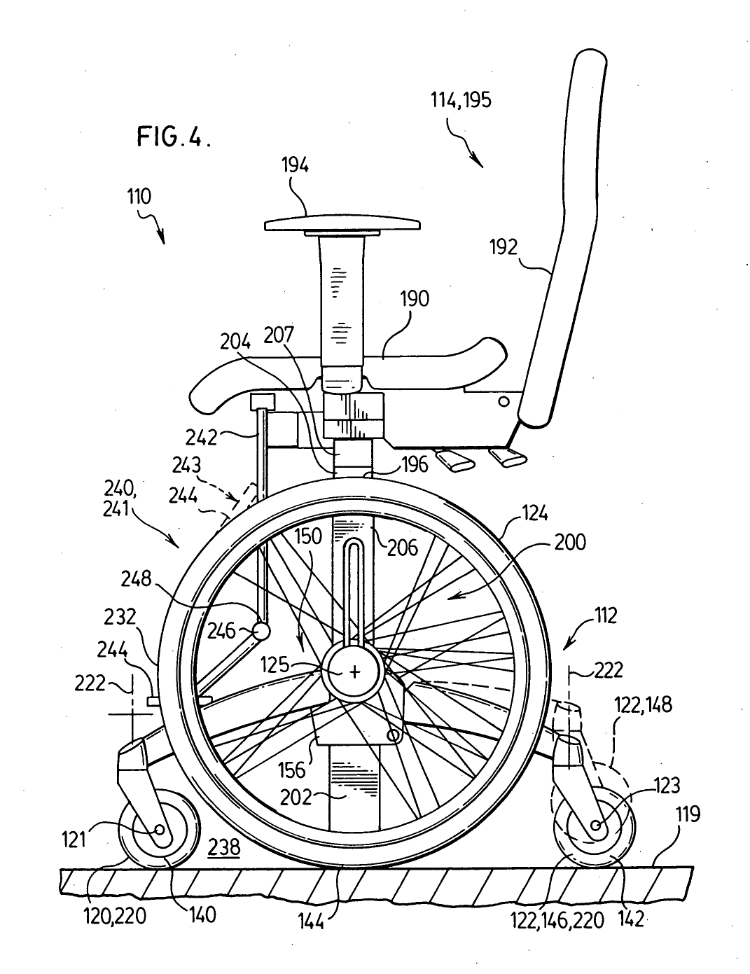

When all wheels are in contact with a surface at the same elevation, i.e., front, rear, and drive wheels 120, 122, and 124 have respective lowermost portions 140, 142, and 144 that are coplanar, then the chair 110 is positioned on a flat, planar portion of the surface 119 (FIG. 4). This position may be defined as a neutral position. Upon encountering a height inconsistency in the surface 119, e.g., an occupant commences to propel the chair 110 up a ramp or down a ramp, the front and rear wheels 120, 122 would, if their respective axes 121, 123 were fixed relative to the drive wheel axis 125, lift the lowermost portion of the drive wheels 124 up and away from the surface 119 at a point of transition between elevations thereof. Accordingly, in accordance with a preferred embodiment of this invention, to facilitate maintaining engagement of the drive wheels 124 with the floor when encountering height inconsistencies in an uneven surface, at least one of the front or rear wheel axes 121, 123 is movable to lengthen or shorten the distance between the seat and the axes which move, thus permitting all wheels to remain in contact with the surface 119 and avoiding any lifting of the drive wheels 124 when crossing a transition in elevation of the surface 119.

In the preferred embodiment that is illustrated, the pair of rearward support wheels 122 are pivotally mounted to the base 112 of the chair 110. The rear support wheels 122 are movable between a neutral position 146 (shown in solid line in FIG. 4), in which the lowermost surfaces 140, 144, 142 of the front, drive, and rear wheels 120, 124, 122, respectively, are generally coplanar, to a raised position 148 (shown in phantom in FIG. 4), in which the lowermost surfaces 142 of the rear support wheels 122 are vertically raised relative to a plane defined by the lowermost surfaces 140 and 144 of the front support wheels 120 and drive wheels 124, respectively. In other words, when in the raised position 148, if the chair 110 were on a horizontal surface, the rear wheel axis 123 is raised relative to the drive wheel axis 125, to shorten a vertical spacing between axis 123 and the seat. The vertical travel of the rear wheel axis 123 between the raised and neutral positions may be about 15-50 mm or more, and preferably is about 20-30 mm. When moving from the lower end of a ramp to a level surface therebelow, the front wheels, upon contact with the lower level surface, will exert a force on the chair 110 urging the chair to pivot rearwards about the drive wheel axis 125. This puts the rear wheels 122 under a compressive force, bearing against the ramp, which moves the rear wheels 122 from the neutral position 146 to the raised position 148.

The rear support wheels 122 may, in some embodiments, also be movable between the neutral position 146 and a lowered position (not shown). In the lowered position, the lowermost surfaces 142 of the rear support wheels are positioned vertically below a plane defined by the lowermost surfaces 140 and 144 of the front support and drive wheels 120, 124, respectively (i.e., further from the seat). When moving from a level surface down an upper portion of a ramp, the rear wheels 122 would be lifted clear of the level surface prior to engagement with ramp if the wheels 122 are biased to the neutral position. If the wheels 122 are biased to the lowered position, the rear support wheels 122 will move downwards relative the drive wheel axis 125 and towards the surface 119, to maintain engagement therewith.

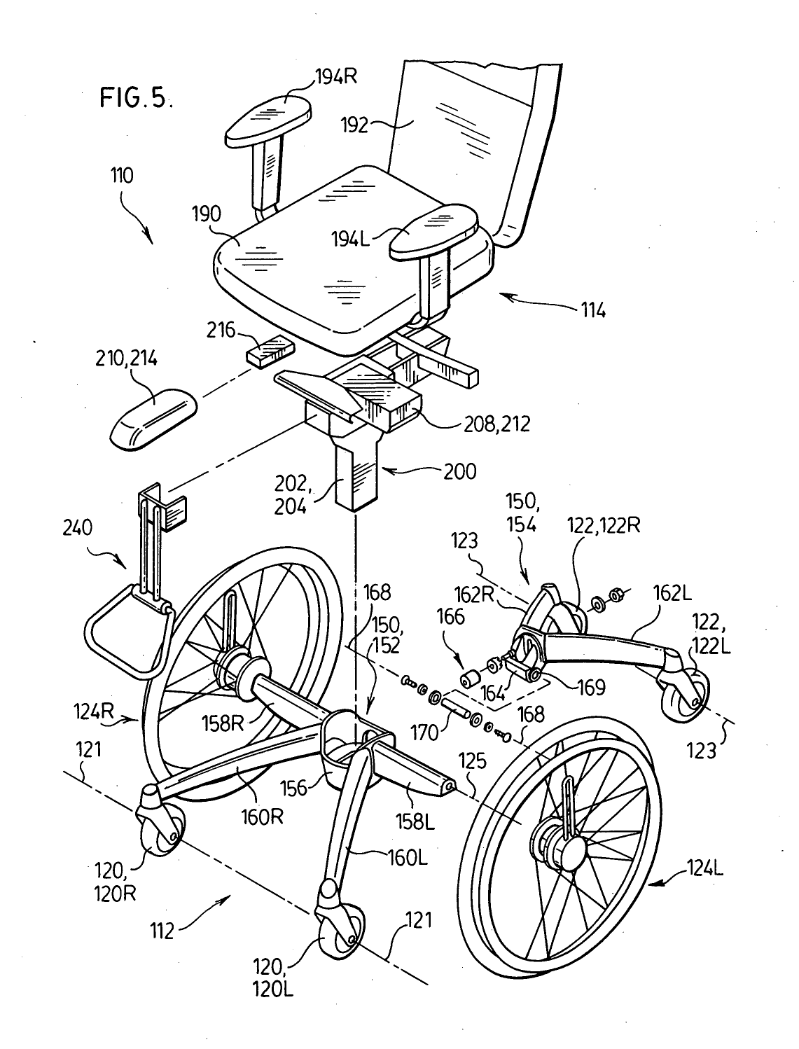

Further details of a preferred base 112 and the adjustable mounting of the rear support wheels 122 to the base 112 can be seen with reference to FIG. 5. In the example illustrated, the base 112 comprises a frame 150 having a front frame sub-assembly 152 and a rear frame sub-assembly 154. The front frame sub-assembly 152 includes a central hub 156, from which laterally opposing left and right drive wheel arms 158L, 158R (generically referred to as drive wheel arms 158) extend. In the example illustrated, the drive wheel arms 158 extend generally along the transverse axis 118.

The preferred front frame subassembly 152 further includes left and right front support wheel arms 160L, 160R extending from the central hub 156, longitudinally towards the front end of the chair 110 and in a laterally diverging manner. The central hub 156, drive wheel arms 158, and the front support wheel arms 160 may be of, for example, but not limited to, cast aluminum alloy construction, or a combination of cast and welded construction, or plastic which can provide the front frame subassembly as a unitary, relatively rigid member.

The preferred rear frame subassembly 154 includes left and right rear support wheel arms 162L, 162R to which the rear support wheels 122 may be secured by any means known in the art. The rear frame subassembly 154 is, in the example, illustrated, pivotally secured to the central hub 156 of the frame 150. The rear frame subassembly 154 may include a central web 164 from which the rear support wheel arms 162 extend longitudinally rearward in a diverging manner.

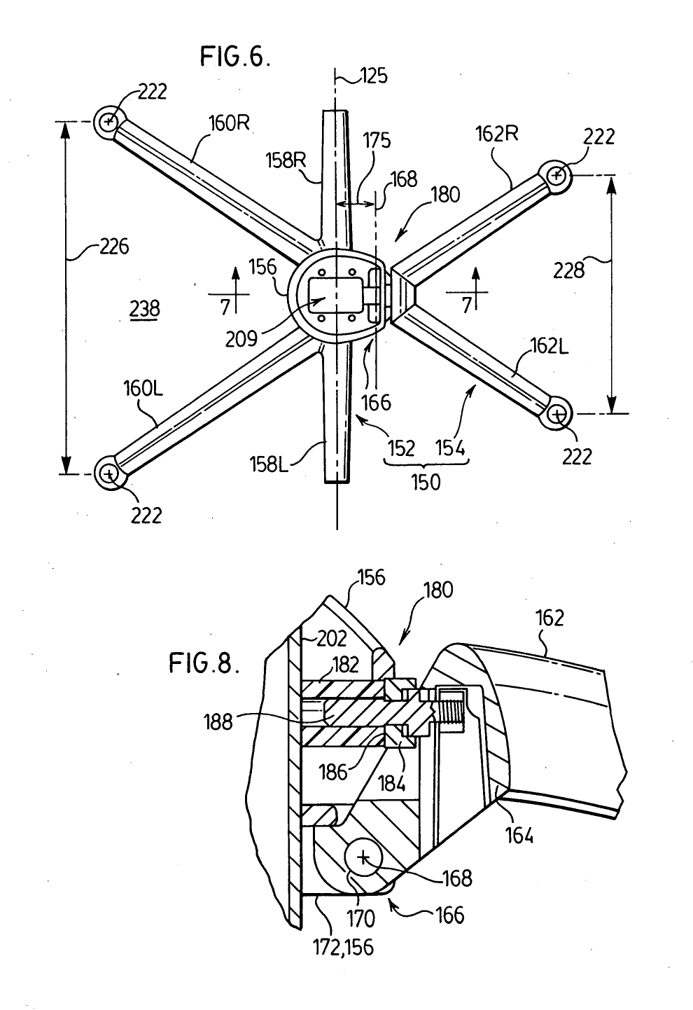

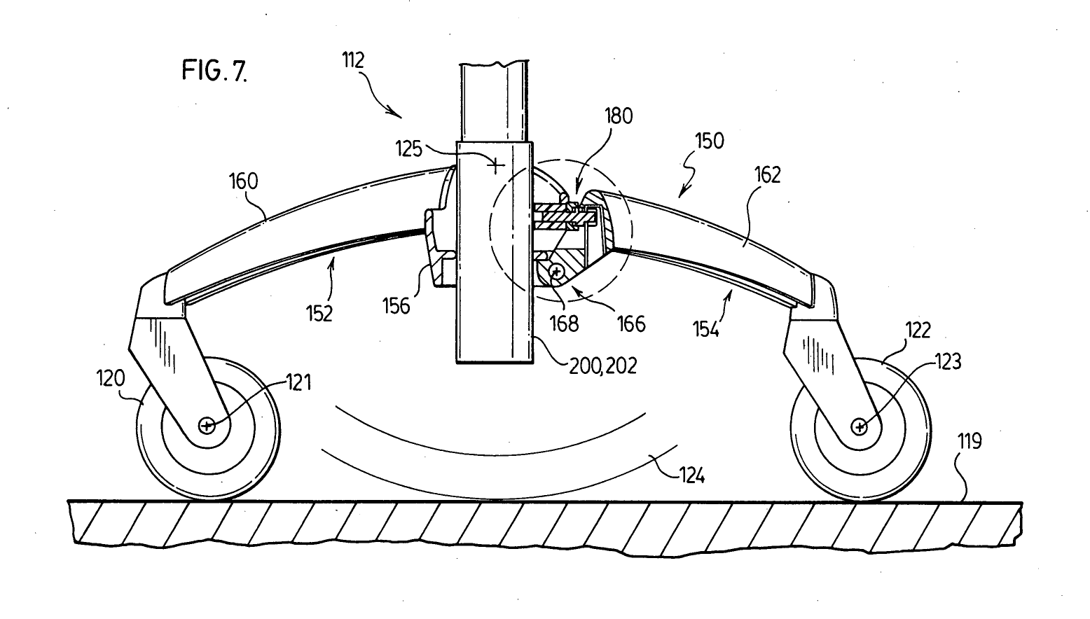

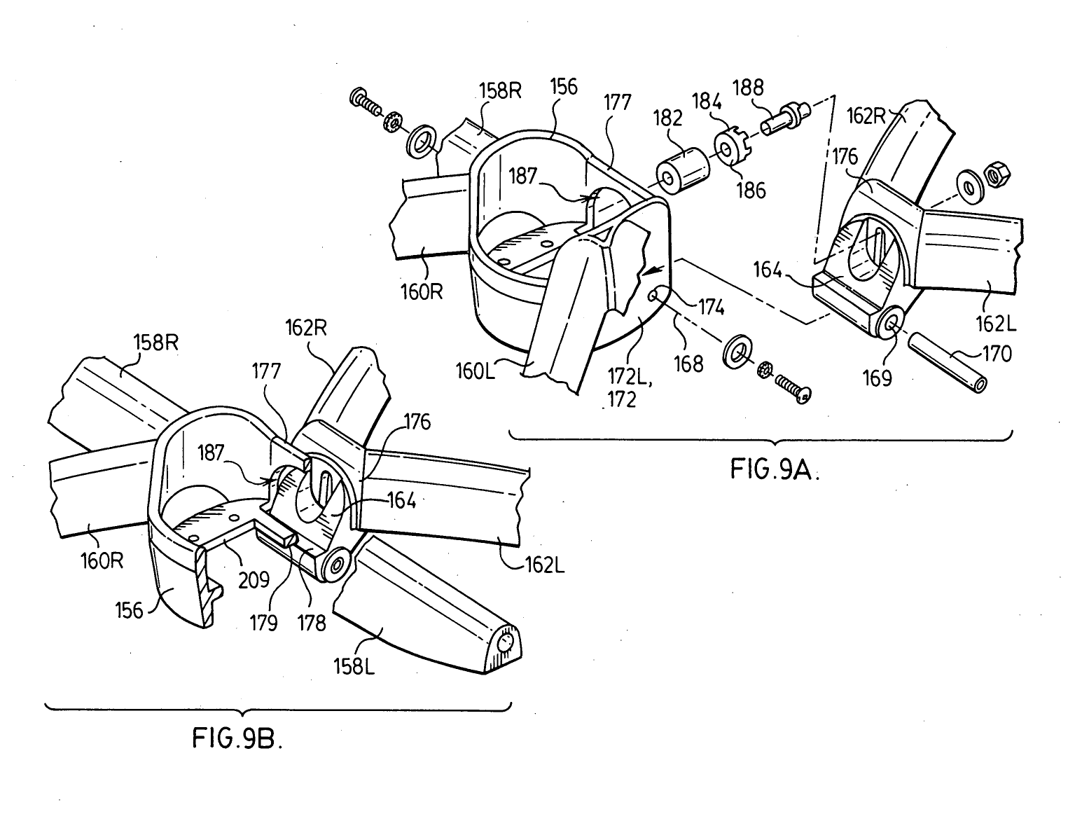

Referring now also to FIGS. 6, 7, and 8, the web 164 is, in the example illustrated, coupled to the central hub 156 by a pivot joint 166 defining a generally horizontal pivot axis 168 about which the rear frame sub-assembly 156 can pivot relative to the front frame subassembly 152. As seen in FIG. 9A, the pivot joint 166 may include a horizontal bore 169 provided in the web 164 for receiving a pivot pin 170 therethrough. The central hub 156 is, in the example illustrated, provided with opposing left and right vertical flanges 172L, 172R, each flange 172 having an aperture 174 therein for securing the pivot pin 170 to the front frame subassembly 152. The pivot pin 170, and hence the pivot axis 168, is in the illustrated embodiment positioned along the longitudinal direction proximate the drive wheel axis 125. The longitudinal spacing between the pivot axis 168 and the drive wheel axis 125 defines a pivot axis offset 175 (FIG. 6). The pivot axis offset 175 is preferably less than the longitudinal spacing between the drive wheel axis 125 and the front support wheels 120, and less than the longitudinal spacing between the drive wheel axis 125 and the rear wheels 122. In the embodiment illustrated, the pivot axis 168 is longitudinally rearward of the drive wheel axis 125, by an axis offset 175 in a range of about 5 to 25 mm.

In use, the rear frame assembly 154, including the rear support wheel arms 162 and rear support wheels 122, can pivot about the pivot pin 170, effecting movement of the rear support wheels 122 between the neutral and vertically raised positions 146, 148, and in some embodiments, between the neutral position 146 and a vertically lowered position. The greatest bending load on the frame 150 when the chair 110 crosses a transition in elevation in the surface 119 will generally be at or near a longitudinally midway point between the front and rear wheels 120, 122, near the seat supporting column 202 and the drive wheel axis 125. Positioning the pivot axis 168 near the drive wheel axis 125 can therefore position the pivot axis where highest bending (or torque) loads are exerted on the frame 150, thus facilitating pivoting of the rear frame subassembly 154 about the pivot axis 168. The chair 110 provides a single pivot joint 166 about which both of the rear wheels 122L, 122R pivot simultaneously in tandem, which can improve lateral stability of the chair 110 when the rear wheels 122 move between, for example, the neutral and raised positions, since each of the laterally spaced apart rear wheels 122L, 122R will be at the same elevation, thus reducing the risk of side-to-side rocking of the chair 110.

As best seen in FIGS. 9A and 9B, the pivot joint 166 may include stop elements to limit the pivoting of the rear frame subassembly 154 about the pivot axis 169 between an upward-most pivot angle and a downward-most pivot angle. In some preferred embodiments, the web 164 of the rear frame subassembly 154 may be provided with a front stop surface 176 extending vertically above the bore 169 and that engages a rear face 177 of the central hub 156 when the rear frame subassembly is in the upward-most pivot position. The web 164 may alternatively or additionally be provided with a horizontal stop surface 178 extending horizontally forward of the bore 169 and that engages an underside surface 179 of the central hub 156 when the rear subassembly 154 is in the downward-most pivot position. The stop elements 176-179 can prevent unwanted over-rotation of the rear frame subassembly 154, which could compromise safety of the chair 110. Limiting the range of pivotability of the rear frame subassembly 154 can also protect the pivot joint 166 and optional biasing mechanism 180 against damage.

In embodiments where the wheels, such as the rear support wheels 122, are adjustably mounted, the frame 150 is preferably provided with a biasing member for biasing the wheels to a biased position. The biased position may correspond to the neutral position 146 (i.e., a position in which all wheels are coplanar) or a lowered position (i.e., the wheels are biased downwardly to a position below the plane defined by the wheels being coplanar).

The biasing member may be a resilient member (e.g. elastomeric) or a spring or any other means known in the art. The pivoting wheels may be pivotally mounted to chair 110 by any means known in the art. For example, an adjustable biasing mechanism 180 may be used for biasing the rear support wheels 122 to a biased position, and for adjusting the position of the rear support wheels 122 relative to the drive wheels 124 when in the biased position. In the embodiment illustrated, the adjustable biasing mechanism 180 biases the rear wheels 122 to the neutral position 146. The mechanism 180 preferably includes a resiliently compressible biasing member 182 secured to the central hub 156, and an abutment member 184 secured to the rear frame subassembly 154, the abutment member 184 presenting an abutment surface 186 for engagement with the biasing member 182.

The mechanism 180 may include, as in the example illustrated, an adjustment rod 188 (FIG. 8) secured to the web 164 of the rear frame subassembly 154 and directed towards the central hub 156 of the front frame subassembly 152. The biasing member 182 may comprise an annular bushing of a resiliently compressible elastomeric material disposed about the adjustment rod 188. The central hub 156 may have an aperture 187 in a rear wall thereof (FIGS. 9A and 9B) for receiving a forward portion of the rod 188 and/or biasing member 182 therethrough. The abutment member 184 may be adjustably secured to the adjustment rod 188, and the biasing member 182 may have opposing longitudinal ends compressively engaged by the abutment member 184 at one end, and an upright 202 fixed to the central hub 156 at the other end.

The mechanism 180 is, in the example illustrated, disposed vertically above the pivot axis 168. The biasing member 182 bears against the abutment surface 186, urging the abutment surface 186 (and thus the rear frame subassembly 154) away from the central hub 156 of the front frame subassembly 152. This exerts a rotational force on the rear frame subassembly 154 about the pivot axis 168, urging the rear frame subassembly 154 to pivot in a clockwise direction when viewed from the left side, and thus urging the rear support wheels 122 downward, to the neutral position 146.

The longitudinal position of the abutment surface 186 relative to the rear frame subassembly 154 may be adjusted, for example by turning the abutment member 184 along a threaded portion of the rod 188, causing a corresponding adjustment in the rotational orientation of the rear frame subassembly 154 about the pivot axis 168, and hence an adjustment in the vertical position of the rear wheel axis 123 with respect to the drive wheel axis 125 when the rear support wheels 122 are in the neutral position 146. It will be appreciated that any biasing member, such as those that use springs, elastomeric members or the like, may be used.

Other optional features that are preferably included in chair 110 are described with reference to FIG. 4. First, it is preferred that chair 110 includes one or more of a seat pan 190, a backrest 192, and a left and right armrest 194L, 194R, and more preferably at least a seat pan 190 and a backrest 192. Secondly, the seat assembly 114 is preferably adjustable between raised and lowered positions 195 (FIG. 3) and 197 (FIG. 2), respectively. Preferably, as shown in the example illustrated, when in the lowered position 197, the seat pan 190 is at an elevation below that of an uppermost or top portion 196 of the drive wheels 124, and the armrests 194 are positioned above the top portion 196 of the drive wheels 124. In this way, the lowered position 197 can facilitate safe and comfortable travel of the chair 110 across the surface 119, by providing a relatively low center of gravity for the occupant relative to the base 112, and by providing comfortable access to the hand rims 128 of the drive wheels 124. This position can facilitate an occupant reaching for an object on a lower shelf of a bookshelf or a lower filing drawer.

When in the raised position 195 (FIGS. 3 and 4), in the example illustrated, the seat pan 190 is preferably positioned above the top portion 196 of the drive wheels 124. This can facilitate positioning an occupant at a variety of heights for working at a desk, counter, or workstation. When in the raised position 195, the occupant can have a relatively high center of gravity relative to the base 112, and it may be desirable to avoid movement of the chair 110 across the surface 119 when the seat assembly 114 is in the raised position 195. This position can facilitate an occupant reaching for an object on an upper shelf of a bookshelf or an upper filing drawer.

The chair 110 may be provided with a brake element (not shown) to prevent rotation of the drive wheels 124 about the drive wheel axis 125. Any brake means known in the wheel chair art may be used. The brake element is preferably configured so that it may be activated when the chair 110 is in the raised position to improve safety of the chair 110.

Any seat height adjustment mechanism known in the art may be used. A preferred example is shown in FIG. 4. As exemplified therein, extendible/retractable lifting mechanism 200 is positioned generally between the seat assembly 114 the base 112 to facilitate raising and lowering of the seat assembly 114. The lifting mechanism 200 includes, in the example illustrated, a tubular housing 202 secured to the central hub 156 of the frame 150. An extendible member 204 has a lower portion 206 telescopically coupled to the tubular housing 202, and an upper end 207 connected to the seat pan 190. The lifting mechanism 200 thus provides a telescoping column supporting the seat assembly 114 above the base 112.

The lifting mechanism 200 may be provided with anti-rotate means, to prevent rotation of the seat assembly 114 relative to the base 112. This advantageously facilitates the proper alignment of the seat pan 190 (and optional arm rests 194) in a prefixed position between the drive wheels 124 when the seat assembly 114 is in (or near) the lowered position. In one preferred embodiment, the anti-rotate means is provided at least in part by the shape of the uprights 202, 204 of the lifting mechanism 200, which are shaped to prevent member 204 from rotating with respect to member 202 and more preferably are generally rectangular in cross-section. The rectangular shape of the extendible member 204 within the corresponding rectangularly shaped tubular housing 202 provides for non-rotation of the extendible member 204 relative to the tubular housing 202. Similarly, the tubular housing 202 is preferably securely fixed to the central hub 156 of the frame 150 and is received within a corresponding rectangular upright aperture 209 provided therein (FIG. 6), so that the tubular housing 202 is non-rotatably secured to the base 112. The seat pan 190 is preferably non-rotatably secured to the upper end 207 of the extendible member 204. Accordingly, the illustrated embodiment provides non-rotatable mounting of the seat assembly 114 to the base 112. Any other means to prevent the rotation of the seat relative to the base 112 may be used. For example, the telescoping column may be circular in cross section with a clamp fixedly mounted to the upper and lower telescoping elements and a guide member extending from one clamp and being slidable received in the other clamp.

Referring again to FIG. 5, to facilitate raising and lowering of the seat assembly 114, the lifting mechanism 200 may include an actuating device 208 driven by a power source 210 to affect displacement of the extendible member 204 within the tubular housing 202. The actuating device 208 preferably includes a height adjustment motor 212 drivingly connected to the seat assembly 114. It will be appreciated that the motor that is used and the method of coupling the motor to the lifting mechanism 200 may be any known in the arts and may vary depending upon the type of lifting mechanism 200 that is used. Preferably, the chair 110 is provided with a battery 214 connected to the motor 212 to provide power thereto. A switch (e.g. a rocker switch) 216 that may be used to control the motor 212 may be mounted for convenient access by an occupant, for example, in or near one of the optional arm rests 194. The actuating device 208 and lifting mechanism 200 can facilitate raising and lowering the seat assembly 114 with the full weight of an occupant therein, so that the need for standing up when raising or lowering the seat assembly 114 is avoided. It will be appreciated that the battery required to power a height adjustment motor may be substantially smaller than that required to power the drive wheels of a wheel chair due to the reduced power required to actuate movement and the fact that fewer actuations may occur in a given day. The battery may be removable mounted so that it is removed for recharging. Alternately, or in addition, the battery may be rechargeable in situ (i.e. the user may plug a recharger into the battery when installed in the chair 110).

The seat assembly 114 may be provided with any additional features known in the office chair arts. For example, the chair 110 may be adjustable to comfortably position an occupant therein. For example, the backrest 192 may be adjustable, both in terms of height and incline relative to the seat pan 190. The optional armrests 194 may also be adjustable in terms of height, lateral distance from the seat pan 190 and incline relative to the seat pan 190. The seat and the backrest may be padded as a standard office chair.

The front and rear support wheels 120, 122 are preferably mounted to swivel about a vertical axis and are more preferably casters 220. As exemplified in FIG. 4, casters 220 may rotate 360° about respective vertical axes 222. Using casters 220 for the front and rear support wheels 120, 122 improves the overall maneuverability of the chair 110, and can help to compensate for any non-rotatability of the seat assembly 114 relative to the base 112. By rotating each of the drive wheels 124 in opposite directions, the chair 110 can generally pivot in place about a fixed vertical axis.

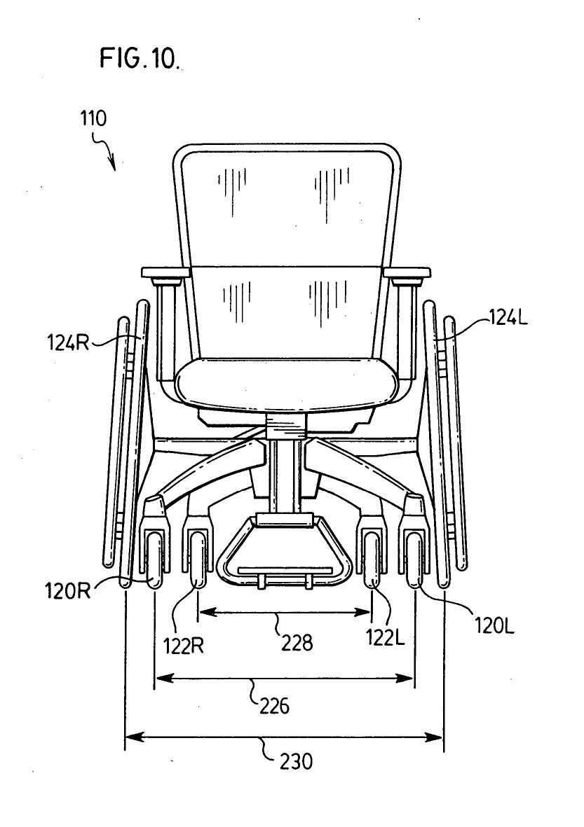

To facilitate maneuverability of the chair 110 and access in tight spaces, the left and right front wheels 120L, 120R and left and right rear wheels 122L, 122R may be spaced apart laterally by a respective front wheel spacing 226 and rear wheel spacing 228 (FIG. 10). Each of the front and rear wheel spacings 226, 228 are preferably narrower than the lateral spacing between the left and right drive wheels 124L, 124R (defining a drive wheel spacing 230), so that the front and rear support wheels 120, 122 are positioned inside of the drive wheels 124, and thus does not define a footprint that is wider than the drive wheels 124.

As seen in FIG. 4, in the longitudinal direction, the front support wheels 120 may extend beyond a front-most portion 232 of the drive wheels 124 (i.e. the arm support for the wheel may be longer than the radius of the drive wheel if the arm supports are co-mounted with the drive wheels). In an alternate embodiment, the front wheel horizontal axis 121 may be no further forward than the front-most portion 232 of the drive wheels 124. In other examples, the front wheel axis 121 can be set rearward of the front-most portion 232 of the drive wheels 124 by an amount generally equal to or greater than the front wheel radius 130, so that the entirety of the front support wheels 120 are generally longitudinally rearward of the front-most portion 232 of the drive wheels 124. The front wheel horizontal axis 121 of the front support wheels 120 may be spaced rearwardly away from the front-most portion 232 by a rearward offset that can be 1 to 150 mm, and preferably75 to 100 mm. Similarly, in some embodiments the rear support wheels 122 may be spaced longitudinally away from the drive wheel axis 125 so that the rear support wheels 122 do not extend past a rear-most portion of the drive wheels 124, or in other words, do not extend rearward from the drive wheel axis 125 by an amount greater than the drive wheel radius 134. Shortening the wheel base (i.e. the longitudinal spacing between the front and rear support wheels 120, 122) of the chair 110 may also help to ensure that the drive wheels 124 remain engaged with the surface 119 when crossing a height inconsistency, since the shorter the wheelbase, the more closely the chair 110 is able to follow the contour of the surface 119.

To further facilitate maneuverability of the chair 110, the chair 110 is preferably adapted to be propelled by engagement of an occupant's feet with the surface 119 on which the chair 110 is situated. Such a method of propelling the chair is generally known as “trippeling” the chair. Accordingly the chair 110 is preferably configured to define an open area 238 (FIGS. 1 and 4) generally vertically below the front end of the seat pan 190, and laterally between the forward portions of the drive wheels 124. In this embodiment, front support wheels 120 are preferably laterally positioned adjacent a respective drive wheel 124. In the example illustrated, the lateral front wheel spacing 226 is greater than the rear wheel spacing 228 to facilitate providing the open, clear area 238 for an occupant's feet to engage the surface 119 (see also FIG. 6).

Furthermore, the chair 110 may be provided with a footrest assembly 240. Preferably, the footrest assembly 240 is configured to be moved between a deployed position 241 (shown in solid line in FIG. 4) for supporting an occupant's feet, and a stowed position 243 (shown in phantom in FIG. 4) to provide the open area 238 provided between the front support wheels 120. The footrest assembly 240 may be mounted by any means known in the art, such as a bracket 242 extending vertically downward from the seat pan 190, and a foot supporting portion 244 attached to the bracket 242.

It is preferred that the footrest assembly 240 is mounted so that, when in the stowed position, the footrest assembly 240 does not interfere with the use of open area 238 to trippel the chair 110. The footrest assembly 240 may be mounted under the seat pan 190 to avoid intrusion in front of, and/or between, the front support wheels 120. The bracket 242, in the example illustrated, extends from a position rearward of the front end of the seat pan 190, and extends only partway down from the seat pan 190 towards the surface 119 on which the chair 110 is situated. The bracket 242 is provided with a horizontal pivot joint 246 at a lower end 248 thereof to which the foot supporting portion 244 is pivotally secured. The foot supporting portion 244 may be generally vertically oriented, and in abutment with the bracket 242 when in the stowed position 243, and may be pivoted forward to, e.g., about 45 degrees below the horizontal when in the deployed position 241. In this configuration, the pivot joint 246 is spaced relatively far rearward and at a relatively high elevation, thus helping to provide the open area 238 for propulsion of the chair 110 by the engagement of an occupant's feet with the surface 119 (i.e. for trippeling the chair).

While the above description provides examples of one or more processes or apparatuses, it will be appreciated that other processes or apparatuses may be within the scope of the accompanying claims.

1. An office chair comprising:
(a) a base comprising:
(i) a pair of centrally positioned, laterally spaced apart drive wheels, the drive wheels having a radius and a top portion;
(ii) at least one forward support wheel mounted at a fixed height;
(iii) at least one rearward support wheel pivotally mounted to the office chair about a horizontal axis; and,
(b) a height adjustable seat mounted to the base and having a front end.

2. The office chair as claimed in claim 1 further comprising a seat height adjustment motor drivingly connected to the seat.

3. The office chair as claimed in claim 2 further comprising a battery connected to the motor.

4. The office chair as claimed in claim 1 wherein the height of the seat is adjustable from a position below the top portion of the drive wheels to a position above the top portion of the drive wheels.

5. The office chair as claimed in claim 1 wherein the seat is non-rotatably mounted to the base.

6. The office chair as claimed in claim 1 wherein the at least one forward support wheel and the at least one rearward support wheel are rotatably mounted to the base.

7. The office chair as claimed in claim 6 wherein the at least one forward support wheel and the at least one rearward support wheel comprise casters.

8. The office chair as claimed in claim 1 wherein the at least one forward support wheel and the at least one rearward support wheel are mounted on arms and the arms are non-rotatably mounted with respect to the drive wheels.

9. The office chair as claimed in claim 1 further comprising a pair of forward support wheels and a pair of rearward support wheels and the forward support wheels and the rearward support wheels are laterally positioned between the drive wheels.

10. The office chair as claimed in claim 9 wherein the forward support wheels and the rearward support wheels extend forwardly less than the radius of the drive wheels.

11. The office chair as claimed in claim 9 wherein the drive wheels are sized to be manually operated by a person when seated in the office chair.

12. The office chair as claimed in claim 9 wherein the forward support wheels and the drive wheels are positioned to define an open area in front of the seat whereby a person feet can touch the surface on which the office chair is situated while seated in the chair and move the office chair with their feet.

13. The office chair as claimed in claim 12 further comprising a footrest that is mounted at a position rearward of the front end of the seat.

14. The office chair as claimed in claim 13 wherein the footrest is pivotally mounted between a generally horizontal in use position and a generally vertical storage position.

15. The office chair as claimed in claim 1 further comprising a seat back wherein the inclination of the seat back with respect to the vertical is adjustable.

16. The Office chair as claimed in claim 1 further comprising a drive motor drivingly connected to the drive wheels.

17. An office chair comprising:
(a) a base comprising:
(i) a pair of centrally positioned, spaced apart drive wheels;
(ii) at least one forward support wheel;
(iii) at least one rearward support;
(b) a height adjustable seat mounted to the base and having a front end; and
(c) a seat height adjustment motor drivingly connected to the seat.

18. The office chair as claimed in claim 17 further comprising a battery connected to the motor.

19. The office chair as claimed in claim 18 wherein the height of the seat is adjustable from a position below the top portion of the drive wheels to a position above the top portion of the drive wheels.

20. The office chair as claimed in claim 17 wherein the seat is non-rotatably mounted to the base.

21. The office chair as claimed in claim 17 wherein the at least one forward support wheel and the at least one rearward support wheel are rotatably mounted to the base.

22. The office chair as claimed in claim 21 wherein the at least one forward support wheel and the at least one rearward support wheel comprise casters.

23. The office chair as claimed in claim 21 wherein the at least one forward support wheel and the at least one rearward support wheel are mounted on arms and the arms are non-rotatably mounted with respect to the drive wheels.

24. The office chair as claimed in claim 17 wherein the office chair has a pair of forward support wheels and a pair of rearward support wheels and the forward support wheels and the rearward support wheels are laterally positioned between the drive wheels.

25. The office chair as claimed in claim 24 wherein the forward support wheels and the rearward support wheels extend forwardly less than the radius of the drive wheels.

26. The office chair as claimed in claim 17 wherein the drive wheels are sized to be manually operated by a person when seated in the office chair.

27. The office chair as claimed in claim 24 wherein the forward support wheels and the drive wheels are positioned to define an open area in front of the seat whereby a person feet can touch the surface on which the office chair is situated while seated in the chair and move the office chair with their feet.

28. The office chair as claimed in claim 27 further comprising a footrest that is mounted at a position rearward of the front end of the seat.

29. The office chair as claimed in claim 28 wherein the footrest is pivotally mounted between a generally horizontal in use position and a generally vertical storage position.

30. The office chair as claimed in claim 17 further comprising a seat back wherein the inclination of the seat back with respect to the vertical is adjustable.

31. An office chair comprising:
(a) a base comprising:
(i) a pair of centrally positioned, spaced apart drive wheels;
(ii) forward support wheels;
(iii) rearward support wheels; and,
(b) a height adjustable seat mounted to the base and having a front end;
wherein the office chair is configured to define an open area in front of the seat whereby a person feet can touch the surface on which the office chair is situated while seated in the chair and move the office chair with their feet.

32. The office chair as claimed in claim 31 further comprising a seat height adjustment motor drivingly connected to the seat and a battery connected to the motor.

33. The office chair as claimed in claim 31 wherein the height of the seat is adjustable from a position below the top portion of the drive wheels to a position above the top portion of the drive wheels.

34. The office chair as claimed in claim 32 wherein the seat is non-rotatably mounted to the base.

35. The office chair as claimed in claim 31 wherein the forward support wheels and the rearward support wheels are rotatably mounted to the base.

36. The office chair as claimed in claim 35 wherein the forward support wheels and the rearward support wheels are mounted on arms and the arms are non-rotatably mounted with respect to the drive wheels.

37. The office chair as claimed in claim 31 wherein the forward support wheels and the rearward support wheels are laterally positioned between the drive wheels.

38. The office chair as claimed in claim 37 wherein the forward support wheels and the rearward support wheels extend forwardly less than the radius of the drive wheels.

39. The office chair as claimed in claim 37 wherein the drive wheels are sized to be manually operated by a person when seated in the office chair.

40. The office chair as claimed in claim 31 further comprising a footrest that is mounted at a position rearward of the front end of the seat.

41. The office chair as claimed in claim 40 wherein the footrest is pivotally mounted between a generally horizontal in use position and a generally vertical storage position.

42. The office chair as claimed in claim 31 further comprising a seat back wherein the inclination of the seat back with respect to the vertical is adjustable.

43. An office chair comprising:
(a) a base comprising:
(i) a pair of centrally positioned, spaced apart drive wheels;
(ii) forward support wheels;
(iii) rearward support wheels;
(b) a height adjustable seat mounted to the base and having a front end; and
(c) an adjustable backrest.

44. The office chair as claimed in claim 43 wherein at least one of the height and inclination of the backrest is adjustable with respect to the seat.
